(19) United States
(12) Patent Application Publication
(10) Pub. No.: US 2024/0386463 A1
(43) Pub. Date: Nov. 21, 2024

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Honami Yuki, Tokyo (JP)

(73) Assignee: NEC Corporation, Minato-ku, Tokyo (JP)

(21) Appl. No.: 18/704,125

(22) PCT Filed: Nov. 22, 2021
(86) PCT No.: PCT/JP2021/042764

§ 371 Date: Apr. 24, 2024

(51) Int. Cl. G06Q 30/0251; G06F 3/01; G06V 40/16

(52) U.S. Cl. CPC G06Q 30/0255; G06F 3/011; G06V 40/168; G06V 40/172

(57) ABSTRACT

An information processing apparatus (10) includes: an authentication control unit (13) that acquires a result of collation between face feature information extracted from a captured image obtained by imaging at least a face of a user and pieces of face feature information of a plurality of persons registered in advance in a case where the user is located in front of a mirror; a selection unit (14) that selects, as a recommended product, at least one product from among a plurality of products based on user information related to the user registered in advance in a case where the collation result indicates that face authentication has succeeded; and a display control unit (15) that outputs display information related to the recommended product to a display device provided in association with the mirror.

### TECHNICAL FIELD

The present disclosure relates to an information processing apparatus, an information processing system, an information processing method, and a non-transitory computer-readable medium, and more particularly, to an information processing apparatus, an information processing system, an information processing method, and a non-transitory computer-readable medium that provide recommendation information to a user.

### BACKGROUND ART

A method for recommending a cosmetic product suitable for a user has been proposed. For example, Patent Literature 1 discloses a makeup assistance apparatus that selects a similar user based on a preference of a first user in a case where authentication of the first user has succeeded, and displays, on a display device, cosmetic product information regarding a cosmetic product used for makeup of the similar user.

### CITATION LIST

### Patent Literature

Patent Literature 1: International Patent Publication No. WO2018/029963

### SUMMARY OF INVENTION

### Technical Problem

Here, there is a need to enhance a sales promotion effect by making it possible to recommend a cosmetic product suitable for a user without requiring a special intention of the user of intentionally logging in for the purpose of purchasing a cosmetic product. Such a need is not limited to cosmetic products, and the same applies to other products.

In view of the above-described problems, an object of the present disclosure is to provide an information processing apparatus, an information processing system, an information processing method, and a non-transitory computer-readable medium capable of enhancing a sales promotion effect.

### Solution to Problem

An information processing apparatus according to an aspect of the present disclosure includes:
authentication control means for acquiring a result of collation between face feature information extracted from a captured image obtained by imaging at least a face of a user and pieces of face feature information of a plurality of persons registered in advance in a case where the user is located in front of a mirror;
selection means for selecting, as a recommended product, at least one product from among a plurality of products based on user information related to the user registered in advance in a case where the collation result indicates that face authentication has succeeded; and
display control means for outputting display information related to the recommended product to a display device provided in association with the mirror.

An information processing system according to an aspect of the present disclosure includes:
an information processing apparatus; and
a face authentication apparatus,
in which the information processing apparatus includes:
authentication control means for acquiring, from the face authentication apparatus, a result of collation between face feature information extracted from a captured image obtained by imaging at least a face of a user and pieces of face feature information of a plurality of persons registered in advance in a case where the user is located in front of a display device to which a mirror is added on a side facing the user;
selection means for selecting, as a recommended product, at least one product from among a plurality of products based on user information related to the user registered in advance in a case where the collation result indicates that face authentication has succeeded; and
display control means for outputting display information related to the recommended product to the display device.

An information processing method according to an aspect of the present disclosure includes:
acquiring a result of collation between face feature information extracted from a captured image obtained by imaging at least a face of a user and pieces of face feature information of a plurality of persons registered in advance in a case where the user is located in front of a mirror;
selecting, as a recommended product, at least one product from among a plurality of products based on user information related to the user registered in advance in a case where the collation result indicates that face authentication has succeeded; and
outputting display information related to the recommended product to a display device provided in association with the mirror.

A non-transitory computer-readable medium according to an aspect of the present disclosure stores a program for causing a computer to execute:
a procedure of acquiring a result of collation between face feature information extracted from a captured image obtained by imaging at least a face of a user and pieces of face feature information of a plurality of persons registered in advance in a case where the user is located in front of a mirror;
a procedure of selecting, as a recommended product, at least one product from among a plurality of products based on user information related to the user registered in advance in a case where the collation result indicates that face authentication has succeeded; and
a procedure of outputting display information related to the recommended product to a display device provided in association with the mirror.

### Advantageous Effects of Invention

According to the present disclosure, a product can be recommended without requiring a special intention of a user, and thus, it is possible to provide an information processing apparatus, an information processing system, an information processing method, and a non-transitory computer-readable medium capable of enhancing a sales promotion effect.

### BRIEF DESCRIPTION OF DRAWINGS

FIG. 1 is a block diagram illustrating a configuration of an information processing apparatus according to a first example embodiment.

FIG. 2 is a flowchart illustrating a flow of an information processing method according to the first example embodiment.

FIG. 3 is a block diagram illustrating an overall configuration of an information processing system according to a second example embodiment.

FIG. 4 is a block diagram illustrating a configuration of a mirror signage according to the second example embodiment.

FIG. 5 is a block diagram illustrating a configuration of a face authentication apparatus according to the second example embodiment.

FIG. 6 is a flowchart illustrating a flow of a face information registration process according to the second example embodiment.

FIG. 7 is a flowchart illustrating a flow of a face authentication process according to the second example embodiment.

FIG. 8 is a block diagram illustrating a configuration of a user terminal according to the second example embodiment.

FIG. 9 is a block diagram illustrating a configuration of a server according to the second example embodiment.

FIG. 10 is a sequence diagram illustrating an example of a flow of a user registration process according to the second example embodiment.

FIG. 11 is a sequence diagram illustrating an example of a flow of an information providing process according to the second example embodiment.

FIG. 12 is a view illustrating an example of display on a display device of the mirror signage according to the second example embodiment.

FIG. 13 is a view illustrating an example of display on the display device of the mirror signage according to the second example embodiment.

FIG. 14 is a view illustrating an example of display on the display device of the mirror signage according to the second example embodiment.

FIG. 15 is a block diagram illustrating a configuration of a server according to a third example embodiment.

FIG. 16 is a sequence diagram illustrating a modified example of a flow of an information providing process according to the third example embodiment.

FIG. 17 is a view illustrating an example of a captured image according to the third example embodiment.

FIG. 18 is a view illustrating an example of display on a display device of a mirror signage according to the third example embodiment.

FIG. 19 is a view illustrating an example of the captured image according to the third example embodiment.

### EXAMPLE EMBODIMENT

Example embodiments of the present disclosure will be described in detail below with reference to the drawings. In the drawings, the same or corresponding elements are denoted by the same reference numerals, and repeated description thereof will be omitted as necessary to clarify the description.

### Problems of Example Embodiment

Here, problems of the example embodiment will be described again.

In stores that sell cosmetic products such as department stores, salespersons propose cosmetic products suitable for customers. However, due to the spread of infectious diseases, an increasing number of customers avoid face-to-face services, and a decrease in sales of cosmetic products in real stores has become a problem. Cosmetic products are deeply associated with the preference and skin type of each customer, and thus there is a problem that it is difficult to effectively retroact to customers in a case where cosmetic products cannot be recommended at the store.

Therefore, as in Patent Literature 1 described above, a method for recommending a cosmetic product suitable for a user has been proposed. However, in a case where a special intention or operation of the user is required, such as a case where the user has to intentionally log in for the purpose of purchasing a cosmetic product or a complicated input operation is required, a sales promotion effect becomes limited. In addition, the necessity of a special operation by the user also becomes a factor of limiting the sales promotion effect. Therefore, it is required to enhance the sales promotion effect by making it possible to recommend a cosmetic product without requiring a special intention or operation of the user.

The above-described problem is particularly remarkable for cosmetic products, but the same applies to other products in addition to cosmetics products.

The present example embodiment has been made to solve such a problem.

### Description of Terms

In the following, the following terms are defined as follows.

A “user ID” is information for identifying a user. The “user ID” may be a user name, or may be a telephone number, a credit card number, or another identification number of the user.

“User information” is information regarding the user. The “user information” includes attribute information of the user. Furthermore, the “user information” may include a use history of the user and input information of the user.

A “product” is any product sold at a real shop or an online shop. The “product” is preferably a cosmetic product, clothing, a hat, an accessory, a bag, shoes, or other product that can be worn by the user. However, the “product” may be a product that the user cannot wear.

The “use history” indicates at least one of a fact that the user uses a real shop that handles a product, a fact that the user has ordered or purchased a product at a real shop or online, or a fact that the user has made a sample delivery request.

### First Example Embodiment

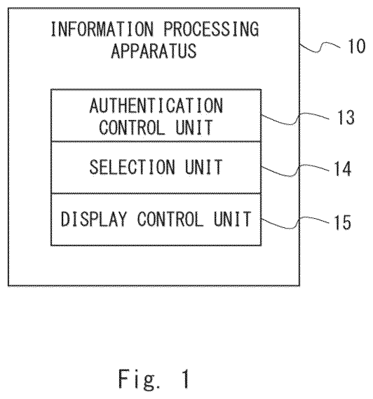

Next, a first example embodiment of the present disclosure will be described. FIG. 1 is a block diagram illustrating a configuration of an information processing apparatus 10 according to the first example embodiment. The information processing apparatus 10 is a computer apparatus that recommends a product to a user located in front of a mirror. Being located in front of the mirror may be standing in front of the mirror or sitting in front of the mirror. For example, the user stands in front of the mirror to adjust his/her appearance.

Here, the information processing apparatus 10 is connected to a network (not illustrated). The network may be a wired network or a wireless network. A display device (not illustrated) provided in association with the mirror may be connected to the network. The information processing apparatus 10 includes an authentication control unit 13, a selection unit 14, and a display control unit 15.

The authentication control unit 13 is also referred to as authentication control means. In a case where the user is located in front of the mirror, the authentication control unit 13 acquires a result of collation between face feature information extracted from a captured image obtained by imaging at least a face of the user and pieces of face feature information of a plurality of persons registered in advance. That is, the authentication control unit 13 acquires a face authentication result of the user located in front of the mirror. By doing so, the authentication control unit 13 specifies the user. For example, the authentication control unit 13 specifies the user ID.

The selection unit 14 is also referred to as selection means. In a case where the collation result acquired by the authentication control unit 13 indicates that face authentication has succeeded, the selection unit 14 selects at least one product from among a plurality of products as a recommended product based on user information. The user information is registered in advance in a user database (DB) (not illustrated) in association with the user. Information regarding the plurality of products is registered in a product database (DB) (not illustrated) in advance.

The display control unit 15 is also referred to as display control means. The display control unit 15 outputs display information related to the recommended product selected by the selection unit 14 to the display device provided in association with the mirror described above. The display information may be product information of the recommended product, information indicating a purchase location of the recommended product, or information for delivering or receiving an order of a sample of the recommended product. Furthermore, the display information may be a simulation image in a case where the user uses the recommended product. Outputting may be transmitting or transmitting and displaying.

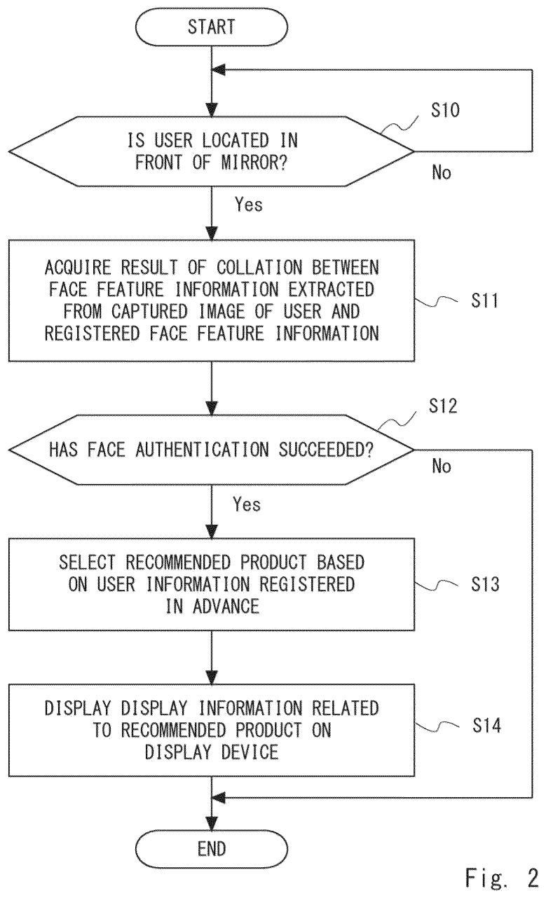

FIG. 2 is a flowchart illustrating a flow of an information processing method according to the first example embodiment. First, the authentication control unit 13 of the information processing apparatus 10 determines whether or not the user is located in front of the mirror (S10). For example, the authentication control unit 13 may determine that the user is located in front of the mirror in a case where a person region of a predetermined size or more is detected from a video of a camera (not illustrated) that captures a landscape around the mirror. The authentication control unit 13 may determine that the user is located in front of the mirror in a case where the person region having the predetermined size or more is detected from the video for a predetermined time or more. In addition, the authentication control unit 13 may determine that the user is located in front of the mirror in a case where a predetermined input operation is performed or in a case where a person is detected by a motion sensor.

In a case where it is determined that the user is located in front of the mirror (Yes in S10), the authentication control unit 13 acquires a result of collation between the face feature information extracted from the captured image of the user and the face feature information of the plurality of persons registered in advance (S11). For example, the authentication control unit 13 may acquire the collation result (that is, the face authentication result) by performing face authentication using the captured image of the user. Furthermore, for example, the authentication control unit 13 may acquire the collation result by transmitting the captured image of the user or the face feature information extracted from the captured image to a face authentication apparatus (not illustrated) connected via the network and receiving the collation result from the face authentication apparatus.

Next, the authentication control unit 13 determines whether or not the face authentication has succeeded (S12). The fact that the face authentication has succeeded indicates that the face feature information of the user and the face feature information of any registered user match. The matching may indicate that the degree of matching of the face feature information is a predetermined value or more.

In a case where the face authentication has not succeeded (No in S12), the information processing apparatus 10 ends the process.

On the other hand, in a case where the face authentication has succeeded (Yes in S12), the selection unit 14 selects the recommended product based on the user information registered in advance (S13). As an example, the selection unit 14 analyzes a preference or orientation of the user based on the user information and selects a product having a product attribute that aligns with the preference or orientation as the recommended product among a plurality of predetermined products. Further, as an example, the selection unit 14 analyzes the preference or orientation of the user based on the user information and selects a product of a manufacturer or brand that aligns with the preference or orientation as the recommended product among the plurality of predetermined products. Furthermore, as an example, the selection unit 14 selects a product having a product attribute suitable for a skin type or skin color of the user included in the user information as the recommended product among the plurality of predetermined products.

Next, the display control unit 15 outputs the display information related to the recommended product to the display device (S14).

As described above, according to the first example embodiment, the information processing apparatus 10 performs the face authentication when the user uses the mirror to perform identity verification, and provides information regarding the recommended product personalized to the user. A special intention or operation of the user such as intentionally logging in is not required to obtain information regarding the recommended product. As a result, the sales promotion effect can be enhanced. In addition, a special operation of the user such as inputting information each time is not required. This can also enhance the sales promotion effect.

### Second Example Embodiment

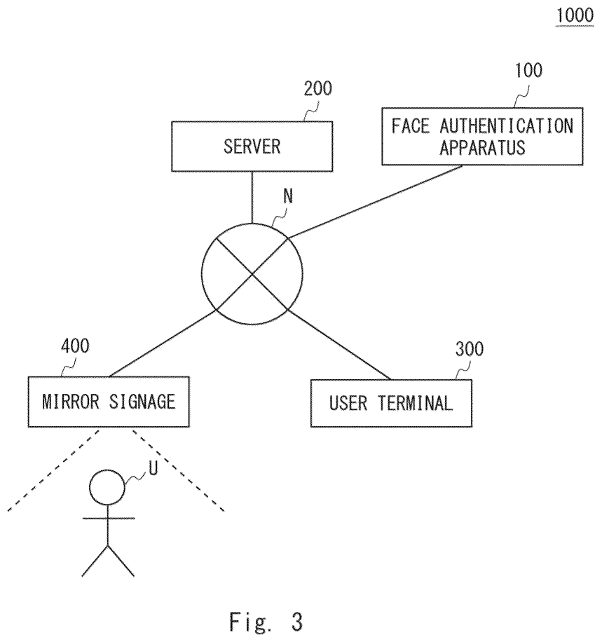

Next, a second example embodiment of the present disclosure will be described. FIG. 3 is a block diagram illustrating an overall configuration of an information processing system 1000 according to the second example embodiment. The information processing system 1000 is a computer system that recommends a product to a user standing in front of a mirror signage including a mirror. In the second example embodiment, the “product” is a cosmetic product as an example.

The information processing system 1000 includes a face authentication apparatus 100, an information processing apparatus (Hereinafter, referred to as a server) 200, a user terminal 300, and a mirror signage 400. The apparatuses and terminals are connected to each other via a network N. Here, the network N is a wired or wireless communication line.

The user terminal 300 is an information terminal used by the user. The user terminal 300 transmits a user registration request to the server 200. As a result, face feature information of the user is registered, and a user ID is issued. The user terminal 300 transmits user information to the server 200, and causes the server 200 to register the user information in association with the user ID.

The mirror signage 400 is a display device with a mirror. The mirror signage 400 functions as a mirror and displays display information. The mirror signage 400 may be provided on a wash basin at the user's home. Furthermore, the mirror signage 400 may be provided in a place used by an unspecified large number of people, for example, a shared space of a company, a store, a wash basin of a shared toilet (particularly, a women's toilet), an elevator, or a waiting space. Further, the mirror signage 400 may be provided at one corner of a cosmetic product section of a department store.

The mirror signage 400 is further provided with a camera (not illustrated) to capture at least a face of a user U located in front of the mirror. Then, the mirror signage 400 transmits the captured image to the server 200 via the network N. As a result, in a case where a person region is included in the captured image, the server 200 starts an information providing process.

The server 200 is an example of the information processing apparatus 10 described above. In a case where the captured image is received from the mirror signage 400 and it is determined that the captured image includes a person, the server 200 executes the information providing process. In the information providing process, the server 200 determines a recommended product based on the user information of the user U specified by the face authentication based on the captured image, and generates the display information related to the recommended product. Then, the server 200 transmits the display information to the mirror signage 400. The mirror signage 400 receives the display information from the server 200 and displays the received display information.

The face authentication apparatus 100 is a computer apparatus that stores pieces of face feature information of a plurality of persons. The face authentication apparatus 100 has a face authentication function of collating a face image or face feature information included in a face authentication request received from the outside with face feature information of each user in response to the face authentication request. In the second example embodiment, the face authentication apparatus 100 registers the face feature information of the user at the time of user registration. Then, the face authentication apparatus 100 acquires the captured image of the user standing in front of the mirror signage 400 from the mirror signage 400 via the server 200, and performs the face authentication using the face region in the captured image. The face authentication apparatus 100 returns a collation result (face authentication result) to the server 200.

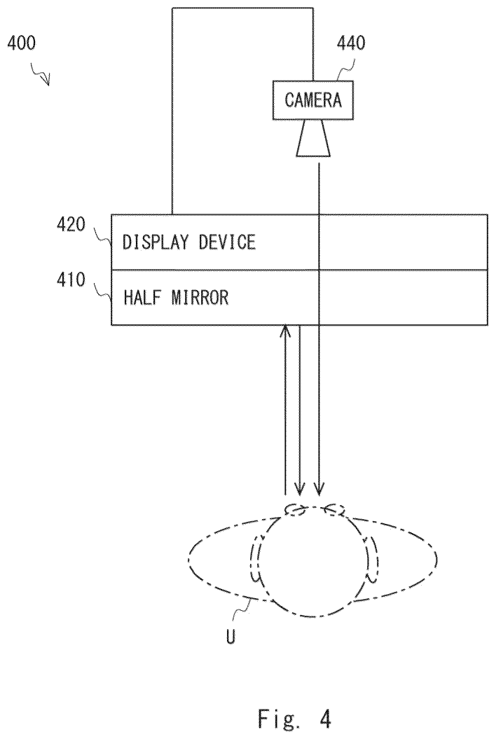

FIG. 4 is a block diagram illustrating a configuration of the mirror signage 400 according to the second example embodiment. The mirror signage 400 includes a half mirror 410 as an example of a mirror, a display device 420, and a camera 440.

The half mirror 410 is a half mirror. Alternatively, the half mirror 410 may be another beam splitter. The half mirror 410 functions as a mirror because the half mirror 410 reflects at least a part of light from a side of the user U located in front of the half mirror 410. As a result, the user U can confirm his/her own appearance. Further, since the half mirror 410 transmits at least a part of light from the display device 420 provided on a back surface side of the half mirror 410, the user U can browse the display information projected on the display device 420.

The camera 440 is connected to the display device 420. For example, the camera 440 is provided on an upper part of the half mirror 410 and is installed in such a way as to be able to capture a landscape in front of the half mirror 410. In a case where the user U stands in front of the half mirror 410, the captured image includes a body region including at least the face of the user U. The camera 440 supplies the captured image to the display device 420.

The display device 420 is a device including a display unit such as a liquid crystal display or an organic EL display. Furthermore, the display device 420 may be a tablet terminal including the display unit. The display device 420 is provided on the back surface side of the half mirror 410. The display device 420 displays the display information received from the server 200 via the network N. In addition, the display device 420 may cause the mirror signage 400 to function as a mirror by displaying and rotating the captured image of the user U located in front of the half mirror 410 to the left and right, the captured image being acquired from the camera 440. The display device 420 may be disposed in the entire region of the half mirror 410, or may be disposed in an upper region of the half mirror 410. For example, the display device 420 may be disposed in a region at a height of 100 cm from the bottom of the half mirror 410, and the display information may be displayed substantially on an upper half portion of the body. Alternatively, the display device 420 may be disposed in a region at a height of 180 cm from the bottom of the half mirror 410, and the display information may be displayed near a head portion.

In addition to the display unit, the display device 420 may include a communication unit (not illustrated) that is a communication interface with the network N, and a control unit (not illustrated) that controls hardware included in the display device 420.

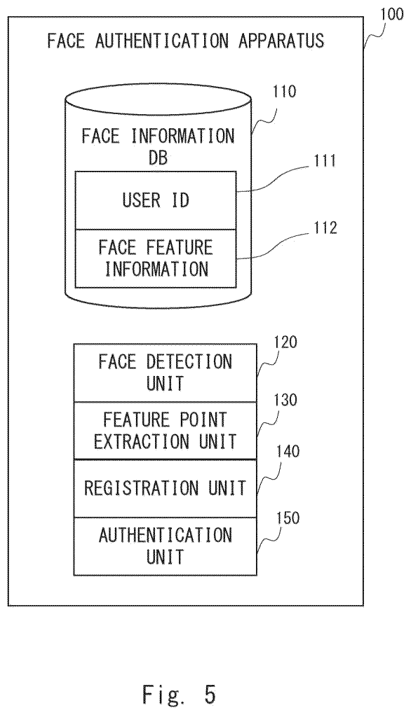

FIG. 5 is a block diagram illustrating a configuration of the face authentication apparatus 100 according to the second example embodiment. The face authentication apparatus 100 includes a face information database (DB) 110, a face detection unit 120, a feature point extraction unit 130, a registration unit 140, and an authentication unit 150. The face information DB 110 stores a user ID 111 and face feature information 112 of the user ID in association with each other. The face feature information 112 is a set of feature points extracted from the face image, and is an example of face information. Note that the face authentication apparatus 100 may delete the face feature information 112 in the face feature DB 110 in response to a request from a user whose face feature information 112 is registered. Alternatively, the face authentication apparatus 100 may delete the face feature information 112 after a lapse of a certain period from the registration of the face feature information 112.

The face detection unit 120 detects a face region included in a registration image for registering the face information, and outputs the face region to the feature point extraction unit 130. The feature point extraction unit 130 extracts a feature point from the face region detected by the face detection unit 120, and supplies the face feature information to the registration unit 140. The feature point extraction unit 130 extracts a feature point included in the captured image received from the server 200, and supplies the face feature information to the authentication unit 150.

The registration unit 140 issues the new user ID 111 when the face feature information is registered. The registration unit 140 registers the issued user ID 111 and the face feature information 112 extracted from the registration image in the face information DB 110 in association with each other. The authentication unit 150 performs the face authentication using the face feature information 112. Specifically, the authentication unit 150 collates the face feature information extracted from the captured image with the face feature information 112 in the face information DB 110. The authentication unit 150 transmits a response indicating whether or not the pieces of face feature information match to the server 200. Whether or not the pieces of face feature information match corresponds to whether or not authentication has succeeded or failed. A case where the pieces of face feature information match (the presence of matching) indicates a case where the degree of matching is equal to or higher than a predetermined value.

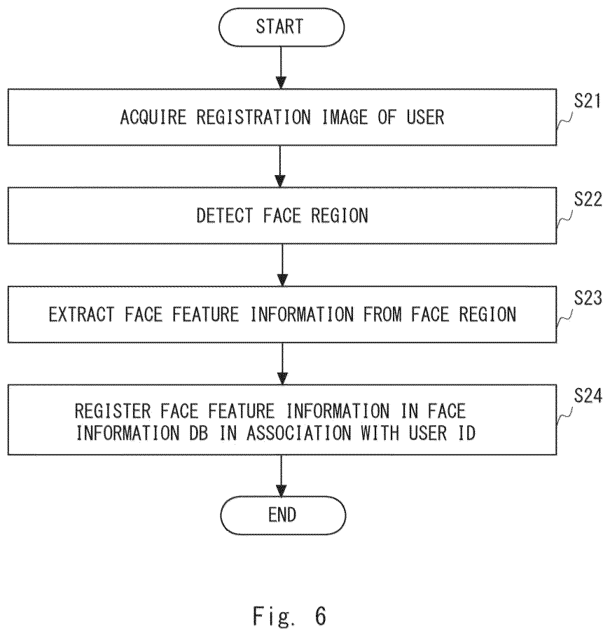

FIG. 6 is a flowchart illustrating a flow of a face information registration process according to the second example embodiment. First, the face authentication apparatus 100 acquires a registration image of the user U included in a face registration request (S21). For example, the face authentication apparatus 100 receives the face registration request from the server 200 that has received a user registration request from the user terminal 300 via the network N. The face authentication apparatus 100 is not limited thereto, and may directly receive the face registration request from the user terminal 300. Next, the face detection unit 120 detects a face region included in the registration image (S22). Next, the feature point extraction unit 130 extracts a feature point from the face region detected in step S22 and supplies face feature information to the registration unit 140 (S23). Finally, the registration unit 140 issues the user ID 111, and registers the user ID 111 and the face feature information 112 in the face information DB 110 in association with each other (S24). The face authentication apparatus 100 may receive the face feature information 112 from a face registration request source and register the face feature information 112 in the face information DB 110 in association with the user ID 111.

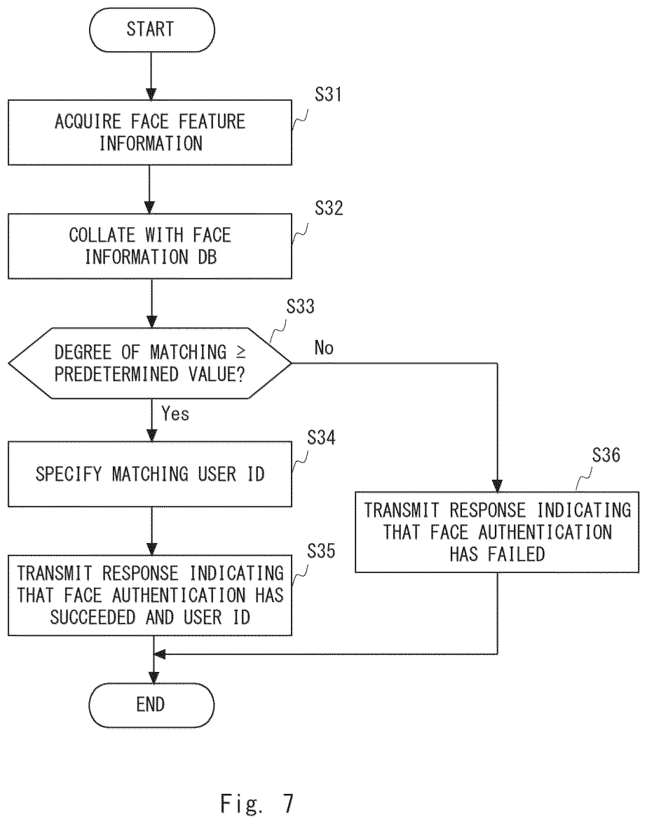

FIG. 7 is a flowchart illustrating a flow of a face authentication process according to the second example embodiment. First, the feature point extraction unit 130 acquires face feature information for authentication (S31). For example, the face authentication apparatus 100 receives a face authentication request from the server 200 via the network N, and extracts face feature information from a captured image included in the face authentication request as in steps S21 to S23. Alternatively, the face authentication apparatus 100 may receive the face feature information from the server 200. Next, the authentication unit 150 collates the acquired face feature information with the face feature information 112 in the face information DB 110 (S32). In a case where the pieces of face feature information match, that is, the degree of matching between the pieces of face feature information is equal to or higher than a predetermined value (Yes in S33), the authentication unit 150 specifies the user ID 111 of the user whose face feature information matches (S34). The authentication unit 150 transmits a response indicating that the face authentication has succeeded and the specified user ID 111 to the server 200 as a face authentication result (S35). In a case where there is no matching face feature information (No in S33), the authentication unit 150 transmits a response indicating that the face authentication has failed to the server 200 as a face authentication result (S36).

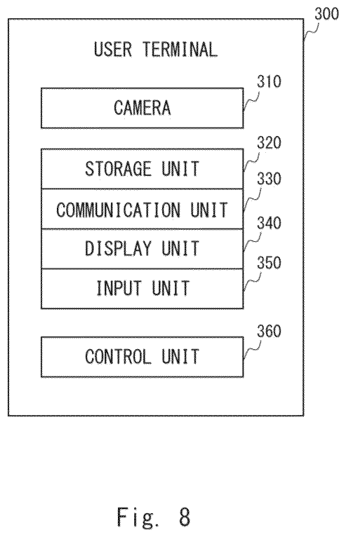

FIG. 8 is a block diagram illustrating a configuration of the user terminal 300 according to the second example embodiment. The user terminal 300 includes a camera 310, a storage unit 320, a communication unit 330, a display unit 340, an input unit 350, and a control unit 360.

The camera 310 is an imaging device that performs imaging under the control of the control unit 360. The storage unit 320 is a storage device that stores a program for implementing each function of the user terminal 300. The communication unit 330 is a communication interface with the network N. The display unit 340 is a display device. The input unit 350 is an input device that receives an input from the user. The display unit 340 and the input unit 350 may be integrally configured similarly to a touch panel. The control unit 360 controls hardware included in the user terminal 300.

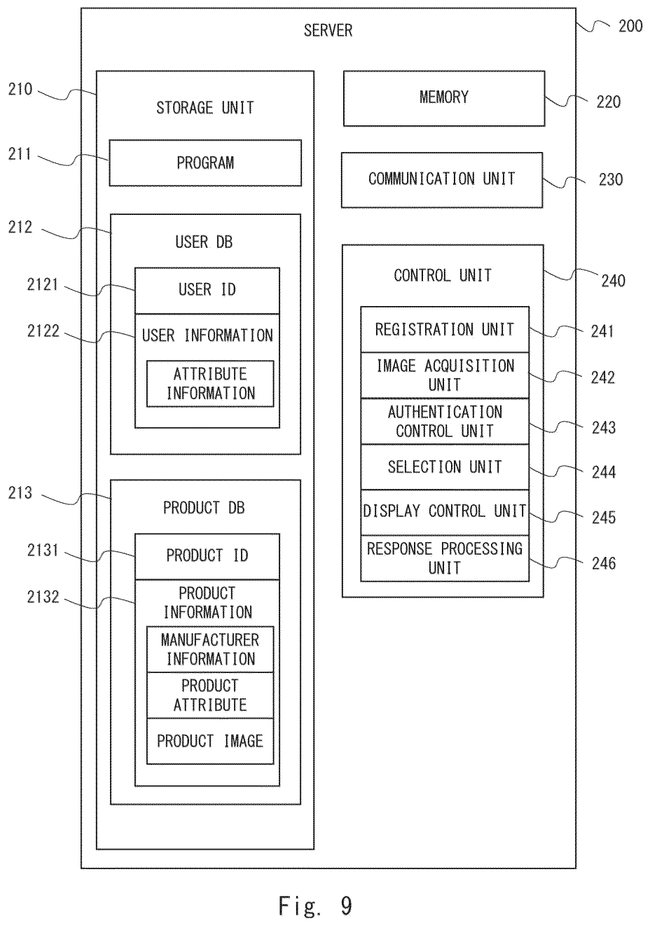

FIG. 9 is a block diagram illustrating a configuration of the server 200 according to the second example embodiment. The server 200 includes a storage unit 210, a memory 220, a communication unit 230, and a control unit 240. The storage unit 210 is a storage device such as a hard disk or a flash memory. The storage unit 210 stores a program 211, a user DB 212, and a product DB 213. The program 211 is a computer program in which processes of the information processing method according to the second example embodiment are implemented.

The user DB 212 stores information regarding a user. Specifically, the user DB 212 stores user information 2122 in association with a user ID 2121. The user ID 2121 is a user ID issued by the face authentication apparatus 100 at the time of face information registration. In the second example embodiment, the user information 2122 includes attribute information of the user. The attribute information may include age, address, sex, occupation, and annual income. Furthermore, the user information 2122 may include registration information regarding the skin type or skin color of the user or a use history of the user. The user information 2122 may include personal information such as a credit card number of the user.

The product DB 213 stores information regarding a product. Specifically, the product DB 213 stores product information 2132 in association with a product ID 2131. The product ID 2131 is information for identifying the product. The product ID 2131 may be a product name or a model number of the product. The product information 2132 is information regarding the product, and may include, for example, manufacturer information, a product attribute, and a product image. The manufacturer information may be a manufacturer ID of a manufacturer who manufactures and sells the product or an ID of a group company of the manufacturer. The manufacturer ID and the group ID may be names or identification numbers thereof. The product attribute is attribute information of the product. For example, the product attribute includes a product type (for example, a skin care product or makeup product, or a foundation product, blusher product, or lip product), a price, a part to which the product is to be applied (for example, skin, cheeks, or lips), or a skin type or skin color (for example, for dry skin and whitening) suitable for the product. In addition, for example, the product attribute may include color information (for example, a color name such as light beige or ochre, or RGB information) and texture information (for example, matte or glossy) of the product.

In addition, the product information 2132 may include a sample product of the product, order destination information of the product, or purchase location information of the product. The order destination information and the purchase location information may include, for example, a uniform resource locator (URL) of an online store that accepts orders and purchases.

The memory 220 is a volatile storage device such as a random access memory (RAM), and is a storage area for temporarily storing information during an operation of the control unit 240. The communication unit 230 is a communication interface with the network N.

The control unit 240 is a processor, that is, a control device that controls each component of the server 200. The control unit 240 reads a program 211 from the storage unit 210 into the memory 220 and executes the program 211. Therefore, the control unit 240 implements the functions of a registration unit 241, an image acquisition unit 242, an authentication control unit 243, a selection unit 244, a display control unit 245, and a response processing unit 246.

The registration unit 241 will also be referred to as registration means. In a case where a registration image has been received from the user terminal 300, the registration unit 241 transmits a face registration request to the face authentication apparatus 100. In a case where the face authentication apparatus 100 registers face information and issues a user ID, the registration unit 241 registers the user ID in the user DB 212. In a case where a user registration request has been received from the user terminal 300, the registration unit 241 registers the user information of the user in the user DB 212 in association with the user ID of the user used by the user terminal 300.

The image acquisition unit 242 will also be referred to as image acquisition means. In a case where a captured image is received from the mirror signage 400, the image acquisition unit 242 supplies the captured image to the authentication control unit 243.

The authentication control unit 243 is an example of the authentication control unit 13 described above. In the second example embodiment, when a person region of a predetermined size or more is detected from the captured image, the authentication control unit 243 starts the following authentication control process. In the authentication control process, the authentication control unit 243 controls face authentication for the face region of the user U included in the captured image, and specifies the user. That is, the authentication control unit 243 causes the face authentication apparatus 100 to perform face authentication on the captured image acquired from the mirror signage 400. For example, the authentication control unit 243 transmits a face authentication request including the acquired captured image to the face authentication apparatus 100 via the network N. The authentication control unit 243 may extract the face region of the user U from the captured image and cause the extracted image to be included in the face authentication request. The authentication control unit 243 may extract face feature information from the face region and cause the face feature information to be included in the face authentication request. The authentication control unit 243 receives a face authentication result from the face authentication apparatus 100. As a result, the authentication control unit 243 specifies the user ID of the user.

The selection unit 244 is an example of the selection unit 14 described above.

The selection unit 244 extracts the user information associated with the user ID specified by the authentication control unit 243 in the user DB 212 by referring to the user DB 212.

Then, the selection unit 244 selects the recommended product from among products of various manufacturers stored in the product DB 213 based on the user information. For example, the selection unit 244 analyzes the preference or orientation of the user based on the attribute information included in the user information. In a case where the use history is included in the user information, the use history may be included in a basis of the analysis.

Then, the selection unit 244 selects, as the recommended product, a product having a product attribute that aligns with the analysis result from among products of various manufacturers stored in the product DB 213 by referring to the product DB 213. In a case where the use history is included in the user information, a purchase cycle for each product type and a purchase history of a product of each product type may be included in a basis of the selection. For example, in a case where the user U has purchased a blusher product three months ago and a purchase cycle for a blusher product is three months, a product whose product type is a blusher product may be preferentially selected as the recommended product. Furthermore, in a case where the user information includes the registration information regarding the skin type or skin color, the registration information may be included in the basis of the selection. For example, the selection unit 244 may preferentially select a product having a product attribute suitable for the skin type or skin color of the user as the recommended product.

Then, the selection unit 244 generates the display information based on the product information of the selected recommended product. For example, the selection unit 244 generates the display information based on information regarding the product name, the manufacturer name, and the price of the selected recommended product and the product image of the selected recommended product. Furthermore, for example, in a case where the order destination information or purchase location information is included in the product information 2132, the selection unit 244 may generate a display image indicating the order destination or the purchase location as the display information. Furthermore, the selection unit 244 may access a website for ordering/purchasing the recommended product, acquire information regarding the recommended product, and generate the display information based on the acquired information.

The display control unit 245 is an example of the display control unit 15 described above. The display control unit 245 transmits the display information generated by the selection unit 244 to the mirror signage 400 and causes the mirror signage 400 to display the display information.

The response processing unit 246 is also referred to as response processing means. In a case where there is a response from the user U as the mirror signage 400 displays the display information, the response processing unit 246 executes a process associated to the response. For example, the process associated to the response is a delivery process of delivering a sample of the recommended product using the personal information (the credit card number or address) of the user, an order process for the recommended product, a payment process for the recommended product, or a delivery process for the recommended product.

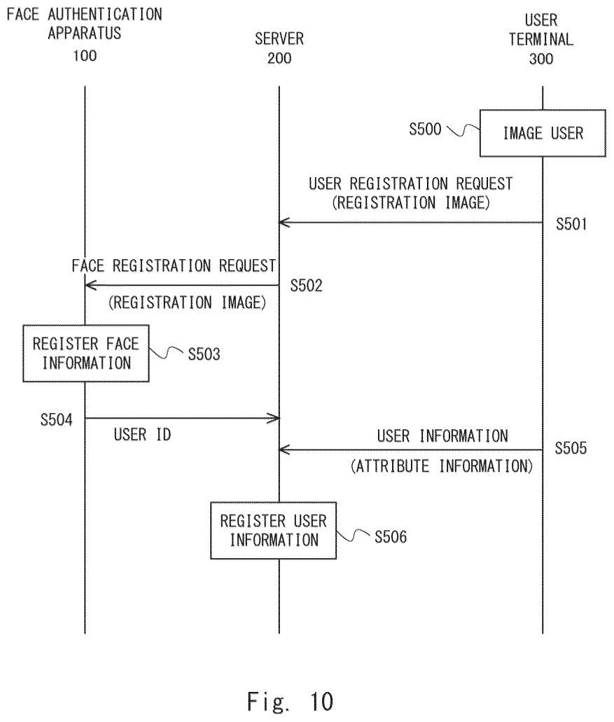

FIG. 10 is a sequence diagram illustrating an example of a flow of a user registration process according to the second example embodiment. First, the user terminal 300 images the user U (S500), and transmits a user registration request including a registration image generated through imaging to the server 200 (S501). The registration unit 241 of the server 200 causes the registration image included in the received user registration request to be included in a face registration request and transmits the face registration request to the face authentication apparatus 100 (S502). The face authentication apparatus 100 registers face information (face feature information) of the user U based on the registration image included in the received face registration request (S503). The face authentication apparatus 100 notifies the server 200 of the issued user ID (S504). The user terminal 300 receives an input of user information from the user, and transmits the user information to the server 200 (S505). The user information transmitted here includes attribute information of the user. The registration unit 241 of the server 200 registers the sent user ID and user information in the user DB 212 in association with each other (S506).

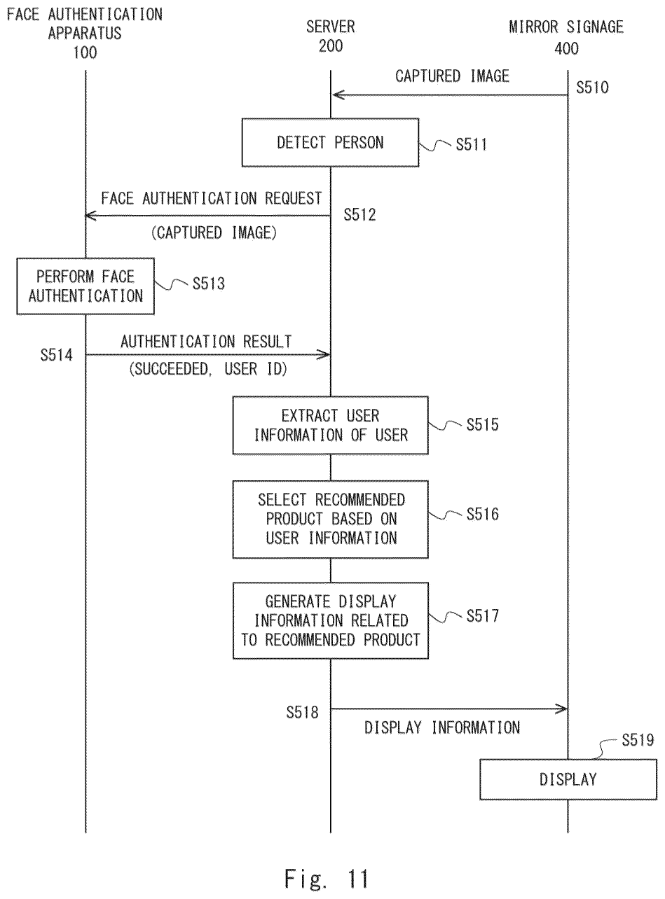

FIG. 11 is a sequence diagram illustrating an example of a flow of the information providing process according to the second example embodiment. First, the mirror signage 400 transmits a captured image obtained by imaging an area in front of the half mirror 410 by the camera 440 to the server 200 (S510). As a result, the image acquisition unit 242 of the server 200 acquires the captured image. Next, the authentication control unit 243 of the server 200 executes a person detection process of determining whether or not a person region of a predetermined size or more is included in the captured image (S511). Here, it is assumed that the person region is included. Then, the authentication control unit 243 of the server 200 transmits a face authentication request for the face region of the user U in the captured image to the face authentication apparatus 100 (S512). At this time, the authentication control unit 243 may include the captured image in the face authentication request, or may include an image obtained by cutting out the person region from the captured image. The face authentication apparatus 100 performs face authentication for the face region of the user U in the face image included in the received face authentication request (S513). Here, it is assumed that there is a user ID that has succeeded in face authentication. The face authentication apparatus 100 transmits the face authentication result including information indicating that the face authentication has succeeded and the user ID to the server 200 (S514). The authentication control unit 243 of the server 200 specifies the user U from the user ID included in the face authentication result.

The selection unit 244 of the server 200 extracts the user information associated with the user ID in the user DB 212 (S515). Next, the selection unit 244 selects the recommended product from among the products stored in the product DB 213 based on the user information (S516). Next, the selection unit 244 generates display information related to the recommended product based on at least a part of the product information of the recommended product (S517).

Next, the display control unit 245 of the server 200 transmits the display information to the mirror signage 400 (S518). Consequently, the display device 420 of the mirror signage 400 displays the display information (S519).

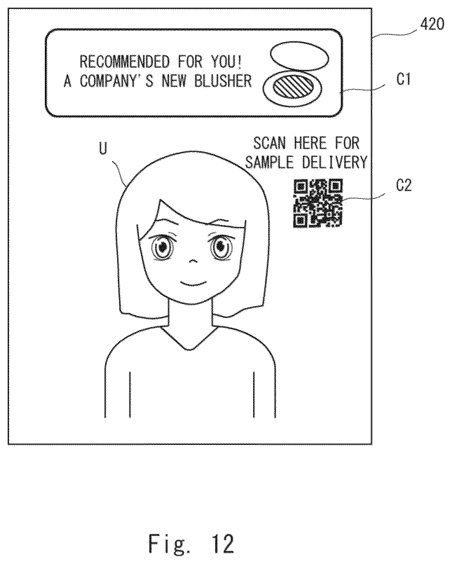

FIG. 12 is a view illustrating an example of display on the display device 420 of the mirror signage 400 according to the second example embodiment. The display unit of the display device 420 displays display information C1 and display information C2. The display information C1 includes the manufacturer name, the product type, and the product image of the recommended product. The display information C2 includes a QR code (registered trademark) indicating a URL of a website for applying for sample product delivery. The user U can read the QR code using the user terminal 300 and request sample delivery. The request for sample delivery can be received by the response processing unit 246. The response processing unit 246 that has received the request may execute a sample delivery process using information regarding an address associated with the user ID in the user DB 212. Therefore, it is not necessary for the user to input the address for the sample delivery request.

The display device 420 may horizontally invert and display the captured image of the user U acquired by the camera 440. However, since the appearance of the user U is reflected on the mirror signage 400 by the half mirror 410, the display device 420 does not have to display the captured image of the user U.

As described above, according to the second example embodiment, the server 200 performs the face authentication when the user uses the mirror to perform identity verification, and provides information regarding the recommended product personalized to the user. A special intention or operation of the user such as intentionally logging in is not required to obtain information regarding the recommended product. Furthermore, since the server 200 selects the recommended product based on the user information (collected in advance in a case where the user information is the use history) registered in advance, the user does not need a special operation such as inputting on the spot. Therefore, the user can easily acquire information regarding a product suitable for the user while adjusting his/her appearance or in a short waiting time. This can enhance the sales promotion effect.

The second example embodiment can be modified as follows.

For example, in a case where the product is a cosmetic product, the display control unit 245 may cause the display device 420 of the mirror signage 400 to output the display information in a display mode associated to a position of a part of the face of the user U. The display mode is, for example, a display position. The selection unit 244 may determine the display position based on the type (for example, a foundation product, a lip product, or a blusher product) of the recommended product stored in the product DB 213 or information regarding the part to which the product is to be applied and the position of the part of the face of the user U included in the captured image.

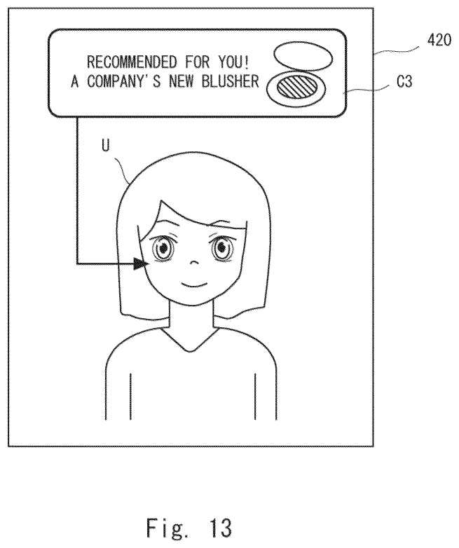

FIG. 13 is a view illustrating an example of display on the display device 420 of the mirror signage 400 according to the second example embodiment. For example, in a case where the type of the recommended product is a blusher product, the display position is a position corresponding to the cheek of the user U included in the captured image. The display device 420 that has received the display information and information regarding the display position from the server 200 displays display information C3 in association with the cheek of the user U on the mirror signage 400 based on the information regarding the display position. In FIG. 13, the display information C3 includes the manufacturer name, the product type, and the product image of the recommended product.

The display information may be a simulation image in a case where the user U uses the recommended product. At this time, the product DB 213 stores style data for generating the simulation image in association with the product ID. For example, the style data includes color information or texture information of the product.

The selection unit 244 reads the style data of the recommended product from the product DB 213 in order to generate the simulation image. Then, the selection unit 244 generates the simulation image in a case where the recommended product is applied to the position of the part of the face of the user U included in the captured image based on the captured image of the user U and the style data. Then, the display control unit 245 transmits the simulation image as the display information to the mirror signage 400 to display the simulation image.

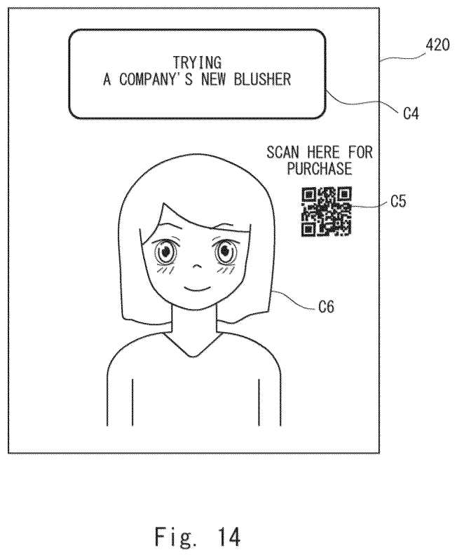

FIG. 14 is a view illustrating an example of display on the display device 420 of the mirror signage 400 according to the second example embodiment. Display information C4 including the manufacturer name and the product type, display information C5 including a QR code indicating a URL of a purchase location website, and a simulation image C6 are displayed on the display device 420. The simulation image C6 may or does not have to include the captured image of the user U. For example, the simulation image C6 may be an image of a cheek portion in a case where the blusher product is used. In this case, the simulation image C6 of the cheek portion is displayed on the appearance of the user reflected on the half mirror 410.

The user U can read a QR code using the user terminal 300 to place an order and make a payment. The order and payment can be performed by the response processing unit 246. The response processing unit 246 may execute the order process and payment process by using the credit card number associated with the user ID in the user DB 212. Furthermore, the response processing unit 246 may execute the delivery process for the product by using the information regarding the address associated with the user ID. Therefore, it is not necessary for the user to input the credit card number or address for order, payment, and delivery.

In addition, not only the above-described display information but also an advertisement of a product provider may be displayed on the display device 420. For example, the display control unit 245 of the server 200 may transmit advertisement data of the product provider to the mirror signage 400 and cause the display device 420 to display the advertisement data.

### Third Example Embodiment

Next, a third example embodiment of the present disclosure will be described. The third example embodiment is characterized in that a server detects an operation from a user and executes a process associated to the operation.

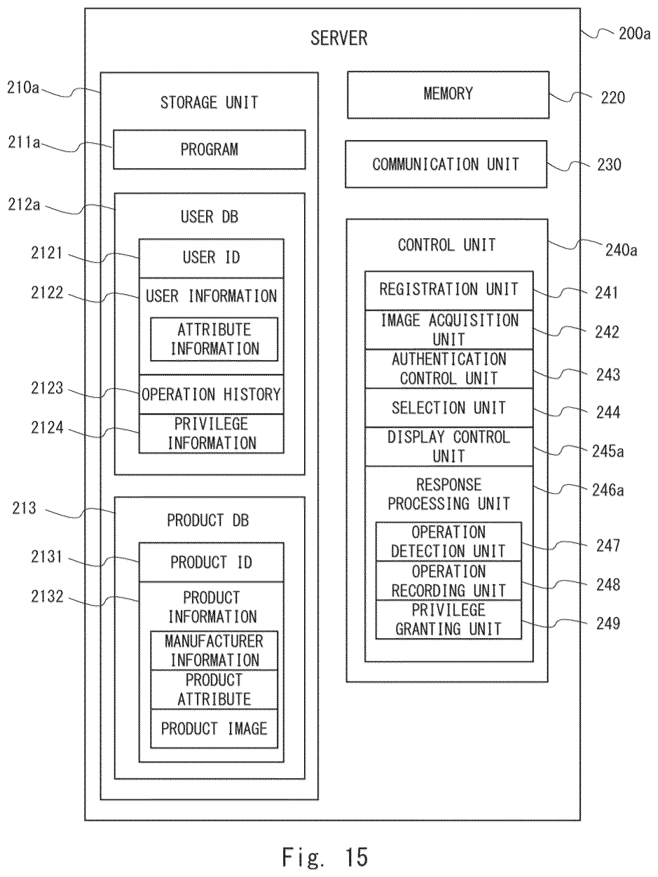

FIG. 15 is a block diagram illustrating a configuration of a server 200a according to the third example embodiment. The server 200a has a configuration and a function basically similar to those of the server 200. However, the server 200a is different from the server 200 in including a storage unit 210a and a control unit 240a instead of the storage unit 210 and the control unit 240.

The storage unit 210a stores a program 211a instead of the program 211 and stores a user DB 212a instead of the user DB 212. The program 211a is a computer program in which processes of an information processing method according to the third example embodiment are implemented.

The user DB 212a is different from the user DB 212 in that an operation history 2123 and privilege information 2124 are further stored in association with a user ID 2121. The operation history 2123 is a history of operations performed by the user in response to display. The privilege information 2124 is information regarding a privilege obtained by the user. The privilege information 2124 may be, for example, information regarding an increase in granted points, coupons, or maximum number of sample deliveries. Furthermore, the privilege information 2124 may include expiration date information of the privilege.

The control unit 240a is different from the control unit 240 in including a display control unit 245a and a response processing unit 246a instead of the display control unit 245 and the response processing unit 246.

The response processing unit 246a detects an operation of the user and executes a process associated to the operation, in addition to the function of the response processing unit 246. In order to execute such a process, the response processing unit 246a may include, for example, an operation detection unit 247, an operation recording unit 248, and a privilege granting unit 249.

The operation detection unit 247 is also referred to as operation detection means. The operation detection unit 247 detects an operation of the user from a captured image of a user U in a case where a mirror signage 400 displays display information. For example, the operation detection unit 247 may recognize that a selection operation has been performed in a case where it is detected from the captured image that the user U has held a hand over an operation region included in the display information or has pointed a finger. In addition, in a case where a predetermined gesture (for example, a finger gesture such as moving a finger from right to left) is detected from the captured image, the operation detection unit 247 may receive execution of a determined process associated to the gesture.

Then, the response processing unit 246a executes a process associated to the operation. For example, the response processing unit 246a generates a simulation image in a case where the user uses a recommended product in response to an operation of requesting display of the simulation image, and supplies the simulation image to the display control unit 245a. A method of generating the simulation image may be similar to the method described in the second example embodiment. In addition, depending on the operation, the response processing unit 246a may execute a process similar to the above-described process received from a user terminal 300 that has read a QR code. For example, a process associated to an operation of requesting sample delivery or requesting an order, payment, or delivery for the recommended product is a delivery process for a sample of the recommended product using personal information (a credit card number or address) of the user, or an order process, payment process, or delivery process for the recommended product.

The operation recording unit 248 is also called operation recording means. The operation recording unit 248 records the operation history in the user DB 212a in association with the user ID. For example, the operation recording unit 248 records, as the operation history, an operation date and an operation type in the user DB 212a. At this time, the operation recording unit 248 may calculate the total number of operations or the number of operations or operation frequency for each operation type, and record the total number of operations or the number of operations or operation frequency for each operation type in the operation history. Further, the operation recording unit 248 may record manufacturer information of the recommended product related to the operation in the operation history.

The privilege granting unit 249 is also referred to as privilege granting means. The privilege granting unit 249 grants a privilege associated to the operation history to the user U. For example, the privilege granting unit 249 reads the operation history stored in the user DB 212a at a predetermined timing. Then, the privilege granting unit 249 grants a larger privilege to the user U as the total number of operations, the number of operations for a predetermined operation type (for example, the number of times of trial or the number of times of purchase), or the number of manufacturers of tried or purchased products is larger. Here, the trial may be requesting display of the simulation image or requesting delivery of a sample. By granting the privilege, it is possible to prompt the user U to perform simulation and request sample delivery. Here, as the number of simulations or sample deliveries increases, an opportunity to try an actual product increases, and thus a desire of purchase increases and a possibility of leading to purchase increases. Therefore, it is possible to encourage the purchase of a product by granting the privilege.

The display control unit 245a transmits a result of the process associated to the operation to the mirror signage 400 and causes a display device 420 to display the result.

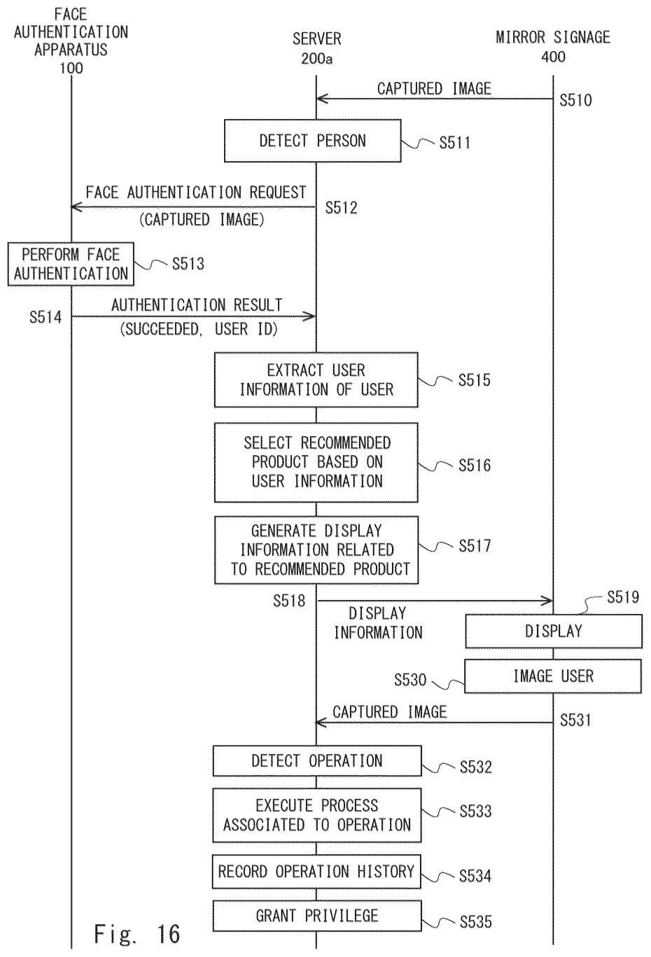

FIG. 16 is a sequence diagram illustrating a modified example of a flow of an information providing process according to the third example embodiment. First, an information processing system 1000 executes processes similar to S510 to S518. Consequently, display information related to the recommended product is displayed on the display device 420 of the mirror signage 400 (S519).

Next, a camera 440 of the mirror signage 400 images the user U on which the display information is being displayed (S530), and transmits the captured image to the server 200a. The operation detection unit 247 of the response processing unit 246a of the server 200a detects an operation of the user U from the captured image (S532). Next, the response processing unit 246a executes a process associated to the operation (S533). Next, the operation recording unit 248 of the response processing unit 246a records the operation history in the user DB 212a in association with the user ID (S534). Then, the privilege granting unit 249 of the response processing unit 246a grants a privilege associated to the operation history 2123 of the user DB 212a to the user, and records the privilege information in the user DB 212a in association with the user ID (S535).

The privilege granting process illustrated in S535 may be executed every time the operation history is updated, or may be executed in a case where a predetermined amount of updated operation history is accumulated. In addition, the privilege granting process may be periodically executed.

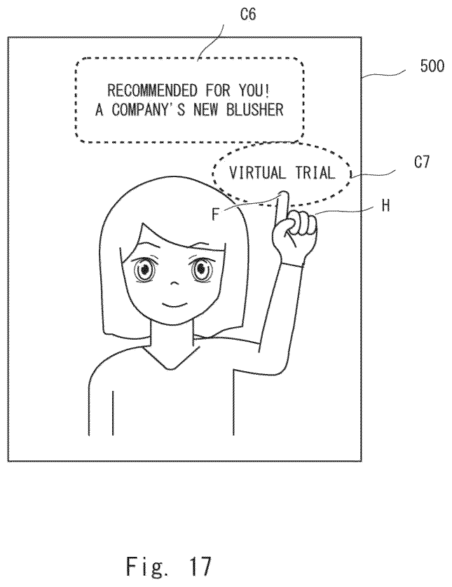

Here, a case where the user U desires to display the simulation image (so-called virtual trial) after the display of the display information in S519 will be described. In this case, the server 200a acquires a captured image 500 illustrated in FIG. 17.

FIG. 17 is a view illustrating an example of the captured image 500 according to the third example embodiment. Display information C6 including a manufacturer name and a product type of the recommended product and display information C7 which is the operation region related to the recommended product are currently displayed on the display device 420 of the mirror signage 400. In FIG. 17, the display information C7 is an operation region for requesting the virtual trial, but is not limited thereto. For example, the display information C7 may be an operation region for requesting browsing of detailed product information of the recommended product, or may be an operation region for requesting access to a website or an EC site of the recommended product. In FIG. 17, display images C6 and C7 currently being displayed are illustrated for the sake of explanation, but the display images C6 and C7 are not included in the captured image 500.

The operation detection unit 247 of the response processing unit 246a of the server 200a detects an operation based on a position of a hand H or a finger F of the user in the captured image 500 and a display position of the display information C7 displayed on the display device 420. For example, in a case where a distance between the position of the hand H or the finger F of the user in the captured image 500 and the display position of the display information C7 displayed on the display device 420 is less than a predetermined threshold, the operation detection unit 247 may determine that a selection operation for the display information C7 has been performed.

In this example, when the operation detection unit 247 detects the selection operation, the response processing unit 246a executes a simulation image generation process as a process associated to the selection operation. Then, the display control unit 245a transmits the simulation image to the mirror signage 400 and causes the display device 420 to display the simulation image. As a result, display similar to that in FIG. 14 described above is performed on the display device 420.

As described above, according to the third example embodiment, since the server 200a detects a simple motion of the user U as an operation by image analysis, in a case where the user shows an interest in the recommended product, it is possible to order a sample or the recommended product itself or make a payment by easily performing the operation. Moreover, the operation is completed without a touch, which is hygienic. Even in a case where the mirror signage 400 is a touch panel, and a touch operation can be detected, an effect is obtained in terms of easy operation.

The third example embodiment can be modified as follows.

For example, in a case where the mirror signage 400 is provided at one corner of a cosmetic product section of a department store, the response processing unit 246a may generate guidance data indicating a selling area for the recommended product that is an operation target as a process associated to the operation of the user U. Then, the display control unit 245 may transmit the guidance data to the mirror signage 400 and cause the display device 420 to display the guidance data. As a result, even in a case where the user U wants to avoid a customer service by a store clerk and contact with other people, the user U can try a plurality of products of a plurality of stores in advance, determine a product, and go straight to a selling area of the product. Therefore, purchase can be effectively promoted.

Furthermore, in the above description, the privilege granting unit 249 grants, to the user U, a privilege associated to an operation history, for example, a privilege associated to the number of “simulations” or “sample deliveries”. At this time, the display control unit 245 may transmit the current number of “simulations” or “sample deliveries” to the mirror signage 400 and cause the display device 420 to display the number.

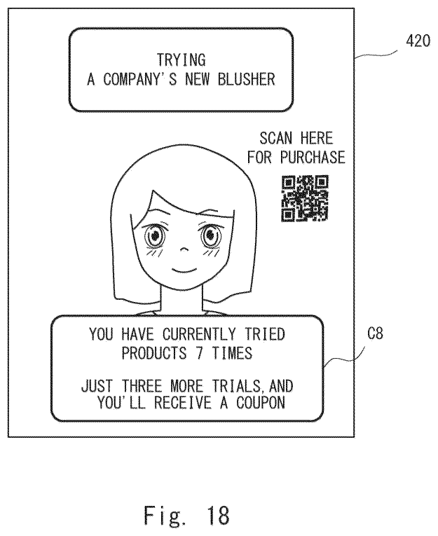

FIG. 18 is a view illustrating an example of display on the display device 420 of the mirror signage 400 according to the third example embodiment. Display information C8 is displayed on the display device 420 in FIG. 18. The display information C8 indicates the current number of trials. In addition, the display information C8 may indicate information regarding how many more trials until a privilege is granted. In FIG. 18, the privilege is a coupon.

Furthermore, the privilege granting unit 249 may grant a privilege associated to a face authentication history to the user U. For example, the privilege granting unit 249 may grant a larger privilege to the user U as the number of face authentications (that is, the number of logins) per predetermined period is larger.

In addition, the privilege granting unit 249 may grant a privilege associated to the operation history to a provider of the product. The provider is, for example, a manufacturer or a distributor. In this case, the operation recording unit 248 of the server 200a may count the number of operations of the user related to the recommended product for each recommended product provider, and the privilege granting unit 249 may grant a privilege associated to the number of operations for the provider to the provider for each recommended product provider. As an example, the privilege granting unit 249 may grant more privilege to the provider as the number of operations for the provider is larger. The privilege for the provider may be a reduction in fee for registering the product of the provider. Furthermore, in a case where an advertisement of the provider can be displayed on the display device 420, the privilege for the provider may be an increase in amount of the advertisement of the provider to be displayed or a reduction in advertisement rate.

In addition, it may be possible to switch a recommendation control mode according to a use scene of the mirror or a mood/situation of the user U. For example, when the user U selects the control mode by performing an operation, the server 200a may switch the recommendation control mode to the selected control mode.

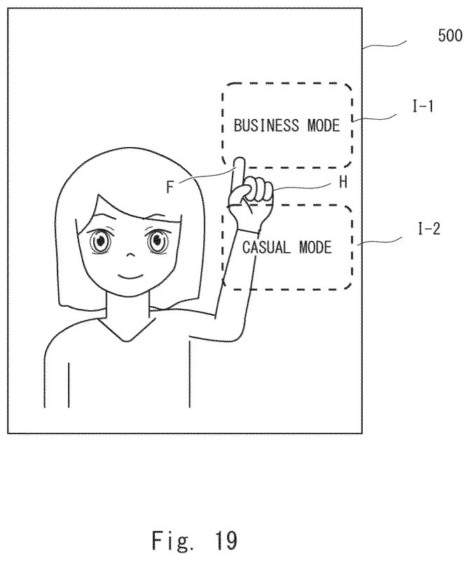

FIG. 19 is a view illustrating an example of the captured image 500 according to the third example embodiment. For example, an operation region I-1 for selecting a business mode and an operation region I-2 for selecting a casual mode are currently displayed on the display device 420 of the mirror signage 400. In FIG. 17, the currently displayed operation regions I-1 and I-2 are illustrated for the sake of explanation, but the operation regions I-1 and I-2 are not included in the captured image 500.

The operation detection unit 247 of the response processing unit 246a of the server 200a detects the selection operation based on the position of the hand H or the finger F of the user in the captured image 500 and a display position of each of the operation regions I-1 and I-2 displayed on the display device 420. Then, the selection unit 244 of the server 200 selects the recommended product based on user information and the type of the selected control mode. In this example, the user U selects the business mode. Therefore, for example, the selection unit 244 may select, from among the products stored in the product DB 213, a product having a product attribute for business as the recommended product, the product attribute aligning with the preference, orientation, skin type, skin color, or the like of the user obtained from the user information.

Thus, recommendation suitable for the use scene of the mirror and the mood/situation of the user U can be implemented. Therefore, the degree of satisfaction of the user U can be further enhanced, and thus, the sales promotion effect can be enhanced. The setting of the control mode does not require the selection operation of the user U, and may be set in advance according to, for example, an installation location of the mirror signage 400 (display device 420) or the date and time of face authentication. As an example, in a case where the mirror signage 400 is installed in an office building, the selection unit 244 may preferentially select a product for business as the recommended product, and in a case where the mirror signage 400 is installed in a commercial facility, the selection unit 244 may preferentially select a casual style product as the recommended product. Furthermore, as an example, in a case where the face authentication is performed in daytime on a weekday, the selection unit 244 may preferentially select a product for business as the recommended product, and in a case where the face authentication is performed in holiday, the selection unit 244 may preferentially select a casual style product as the recommended product. This also makes it possible to improve the degree of satisfaction of the user U and enhance the sales promotion effect.

In the above example embodiments, a configuration of the hardware has been described, but the present disclosure is not limited thereto. In the present disclosure, any processing can also be implemented by causing a processor to execute a computer program.

In the above-described example, the program includes a group of commands (or software codes) for causing the computer to perform one or more functions described in the example embodiments, when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes propagated signals in electrical, optical, acoustic, or any other form.

Note that the present disclosure is not limited to the above example embodiments, and can be appropriately changed without departing from the concept. For example, in the above example embodiments, the selection unit 244 selects the recommended product having a product attribute that aligns with the preference, the orientation, the skin type, or the skin color estimated from the user information. However, the selection unit 244 is not limited thereto, and may estimate a personal color based on the user information and select the recommended product having a product attribute suitable for the personal color. With such a configuration, recommendation reflecting the personal color of the user U becomes possible, and it becomes possible to give the user U an impression that the recommended product is special. As a result, the sales promotion effect is enhanced.

Furthermore, for example, the selection unit 244 may add, to the basis of the selection of the recommended product, a feature of an appearance such as a complexion, clothing, or hairstyle of the user U on that day that can be grasped from the captured image for face authentication. That is, in a case where the face authentication has succeeded, the selection unit 244 selects the recommended product based on information regarding the preference, the feature of the orientation, the skin type, or the skin color estimated based on the user information and a feature of the appearance estimated based on the captured image for face authentication. In addition, the selection unit 244 may diagnose the personal color described above based on the feature of the appearance. With such a configuration, recommendation in consideration of the appearance on that day becomes possible, and it becomes possible to give the user U an impression that the recommended product is special. As a result, the sales promotion effect is enhanced.

In the above example embodiments, the face authentication apparatus 100 has the face authentication function, but the server 200 or 200a may have the face authentication function instead of or in addition to the face authentication apparatus 100.

Some or all of the above example embodiments can be described as in the following Supplementary Notes, but are not limited to the following Supplementary Notes.

### (Supplementary Note 1)

An information processing apparatus including:
authentication control means for acquiring a result of collation between face feature information extracted from a captured image obtained by imaging at least a face of a user and pieces of face feature information of a plurality of persons registered in advance in a case where the user is located in front of a mirror;
selection means for selecting, as a recommended product, at least one product from among a plurality of products based on user information related to the user registered in advance in a case where the collation result indicates that face authentication has succeeded; and
display control means for outputting display information related to the recommended product to a display device provided in association with the mirror.

### (Supplementary Note 2)

The information processing apparatus according to Supplementary Note 1, in which
the mirror is a half mirror, and
the display device is provided on a back surface side of the mirror.

### (Supplementary Note 3)

The information processing apparatus according to Supplementary Note 1 or 2, further including response processing means for detecting an operation of the user and executing a process associated to the operation,
in which the display control means outputs a result of the process associated to the operation to the display device.

### (Supplementary Note 4)

The information processing apparatus according to Supplementary Note 3, in which the process associated to the operation is a delivery process for a sample of the recommended product using personal information of the user registered in advance, or an order process, payment process, or delivery process for the recommended product.

### (Supplementary Note 5)

The information processing apparatus according to Supplementary Note 3 or 4, in which
the process associated to the operation is a process of generating a simulation image in a case where the user uses the recommended product, and
the display control means outputs the simulation image to the display device.

### (Supplementary Note 6)

The information processing apparatus according to any one of Supplementary Notes 3 to 5, in which the response processing means detects the operation based on a position of a hand or a finger of the user in the captured image and a display position of an operation region related to the recommended product displayed on the display device.

### (Supplementary Note 7)

The information processing apparatus according to any one of Supplementary Notes 3 to 6, further including privilege granting means for granting a privilege associated to a history of the operation to the user.

### (Supplementary Note 8)

The information processing apparatus according to any one of Supplementary Notes 3 to 6, further including:
operation recording means for counting, for each recommended product provider, the number of operations of the user related to a corresponding recommended product; and
privilege granting means for granting, for each recommended product provider, a privilege associated to the number of operations for a corresponding provider to the provider.

### (Supplementary Note 9)

The information processing apparatus according to any one of Supplementary Notes 1 to 8, in which the display control means outputs the display information to the display device in a display mode determined based on a type of the recommended product and a position of a part of the face of the user included in the captured image.

### (Supplementary Note 10)

The information processing apparatus according to any one of Supplementary Notes 1 to 9, in which the selection means selects, as the recommended product, at least one product from among the plurality of products based on the user information and a type of a control mode.

### (Supplementary Note 11)

The information processing apparatus according to any one of Supplementary Notes 1 to 10, in which in a case where the face authentication has succeeded, the selection means selects the recommended product based on the user information and a feature of an appearance estimated based on the captured image.

### (Supplementary Note 12)

An information processing system including:
an information processing apparatus; and
a face authentication apparatus,
wherein the information processing apparatus includes:
authentication control means for acquiring, from the face authentication apparatus, a result of collation between face feature information extracted from a captured image obtained by imaging at least a face of a user and pieces of face feature information of a plurality of persons registered in advance in a case where the user is located in front of a mirror;
selection means for selecting, as a recommended product, at least one product from among a plurality of products based on user information related to the user registered in advance in a case where the collation result indicates that face authentication has succeeded; and
display control means for outputting display information related to the recommended product to a display device provided in association with the mirror.

### (Supplementary Note 13)

The information processing system according to Supplementary Note 12, further including the display device.

### (Supplementary Note 14)

An information processing method including:
acquiring a result of collation between face feature information extracted from a captured image obtained by imaging at least a face of a user and pieces of face feature information of a plurality of persons registered in advance in a case where the user is located in front of a mirror;
selecting, as a recommended product, at least one product from among a plurality of products based on user information related to the user registered in advance in a case where the collation result indicates that face authentication has succeeded; and outputting display information related to the recommended product to a display device provided in association with the mirror.

### (Supplementary Note 15)

A non-transitory computer-readable medium storing a program for causing a computer to execute:
a procedure of acquiring a result of collation between face feature information extracted from a captured image obtained by imaging at least a face of a user and pieces of face feature information of a plurality of persons registered in advance in a case where the user is located in front of a mirror;
a procedure of selecting, as a recommended product, at least one product from among a plurality of products based on user information related to the user registered in advance in a case where the collation result indicates that face authentication has succeeded; and
a procedure of outputting display information related to the recommended product to a display device provided in association with the mirror.

### REFERENCE SIGNS LIST

10 INFORMATION PROCESSING APPARATUS
13, 243 AUTHENTICATION CONTROL UNIT
14, 244 SELECTION UNIT
15, 245, 245a DISPLAY CONTROL UNIT
100 FACE AUTHENTICATION APPARATUS
110 FACE INFORMATION DB
111 USER ID
112 FACE FEATURE INFORMATION
120 FACE DETECTION UNIT
130 FEATURE POINT EXTRACTION UNIT
140 REGISTRATION UNIT
150 AUTHENTICATION UNIT
200, 200a INFORMATION PROCESSING APPARATUS (SERVER)
210 STORAGE UNIT
211 PROGRAM
212, 212a USER DB
2121 USER ID
2122 USER INFORMATION
2123 OPERATION HISTORY
2124 PRIVILEGE INFORMATION
213 PRODUCT DB
2131 PRODUCT ID
2132 PRODUCT INFORMATION
220 MEMORY
230 COMMUNICATION UNIT
240, 240a CONTROL UNIT
241 REGISTRATION UNIT
242 IMAGE ACQUISITION UNIT
246, 246a RESPONSE PROCESSING UNIT
247 OPERATION DETECTION UNIT
248 OPERATION RECORDING UNIT
249 PRIVILEGE GRANTING UNIT
300 USER TERMINAL
310 CAMERA
320 STORAGE UNIT
330 COMMUNICATION UNIT
340 DISPLAY UNIT
350 INPUT UNIT
360 CONTROL UNIT
400 MIRROR SIGNAGE
410 HALF MIRROR
420 DISPLAY DEVICE
430 CONTROL DEVICE
431 STORAGE UNIT
432 COMMUNICATION UNIT
433 CONTROL UNIT
440 CAMERA
500 CAPTURED IMAGE
1000 INFORMATION PROCESSING SYSTEM
U USER

What is claimed is:

1-15. (canceled)

16. An information processing apparatus comprising:
at least one memory storing instructions, and
at least one processor configured to execute the instructions to;
acquire a result of collation between face feature information extracted from a captured image obtained by imaging at least a face of a user and pieces of face feature information of a plurality of persons registered in advance in a case where the user is located in front of a mirror;
determine output information based on a feature of an appearance indicating a condition of the user estimated from the captured image and user information related to the user registered in advance in a case where the collation result indicates that face authentication has succeeded; and
output information to a display device provided in association with the mirror.

17. The information processing apparatus according to claim 16, wherein at least one processor is further configured to execute the instructions to:
select, as a recommended product, at least one product from among a plurality of products based on skin information and user information; and
output display information related to the recommended product to the display device provided in association with the mirror.

18. The information processing apparatus according to claim 16, wherein
the mirror is a half mirror, and
the display device is provided on a back surface side of the mirror.

19. The information processing apparatus according to claim 16, wherein at least one processor is further configured to execute the instructions to detect an operation of the user and executing a process associated to the operation, and
a result of the process associated to the operation is output to the display device.

20. The information processing apparatus according to claim 19, wherein the process associated to the operation is a delivery process for a sample of the recommended product using personal information of the user registered in advance, or an order process, payment process, or delivery process for the recommended product.

21. The information processing apparatus according to claim 19 wherein
the process associated to the operation is a process of generating a simulation image in a case where the user uses the recommended product, and
the simulation image is output to the display device.

22. The information processing apparatus according to claim 19, wherein the operation is detected based on a position of a hand or a finger of the user in the captured image and a display position of an operation region related to the recommended product displayed on the display device.

23. The information processing apparatus according to claim 19, wherein at least one processor is further configured to execute the instructions to grant a privilege associated to a history of the operation to the user.

24. The information processing apparatus according to claim 19, wherein at least one processor is further configured to execute the instructions to:
count, for each recommended product provider, the number of operations of the user related to a corresponding recommended product; and
grant, for each recommended product provider, a privilege associated to the number of operations for a corresponding provider to the provider.

25. The information processing apparatus according to claim 16, wherein the display information is output to the display device in a display mode determined based on a type of the recommended product and a position of a part of the face of the user included in the captured image.

26. The information processing apparatus according to claim 17, wherein at least one product from among the plurality of products is selected, as the recommended product, further based on a type of a control mode.

27. An information processing method comprising:
acquiring a result of collation between face feature information extracted from a captured image obtained by imaging at least a face of a user and pieces of face feature information of a plurality of persons registered in advance in a case where the user is located in front of a mirror;
determining output information based on a feature of an appearance indicating a condition of the user estimated from the captured image and user information related to the user registered in advance in a case where the collation result indicates that face authentication has succeeded; and
outputting output information to a display device provided in association with the mirror.

28. A non-transitory computer-readable medium storing a program for causing a computer to execute:
a procedure of acquiring a result of collation between face feature information extracted from a captured image obtained by imaging at least a face of a user and pieces of face feature information of a plurality of persons registered in advance in a case where the user is located in front of a mirror;
a procedure of determining output information based on a feature of an appearance indicating a condition of the user estimated from the captured image and user information related to the user registered in advance in a case where the collation result indicates that face authentication has succeeded; and
a procedure of outputting output information to a display device provided in association with the mirror.
